(19) United States
(12) Patent Application Publication
(10) Pub. No.: US 2021/0204345 A1
(43) Pub. Date: Jul. 1, 2021

(54) METHOD AND DEVICE FOR PROCESSING LINK FAILURE, TERMINAL DEVICE AND STORAGE MEDIUM

(71) Applicant: GUANGDONG OPPO MOBILE TELECOMMUNICATIONS CORP., LTD., Dongguan (CN)

(72) Inventors: ZHIHUA SHI, Dongguan (CN); XIN YOU, Dongguan (CN); WENHONG CHEN, Dongguan (CN)

(21) Appl. No.: 17/203,223

(22) Filed: Mar. 16, 2021

Related U.S. Application Data
(63) Continuation of application No. PCT/CN2018/108412, filed on Sep. 28, 2018.

(51) Int. Cl. H04W 76/18; H04W 76/19

(52) U.S. Cl. CPC H04W 76/18; H04W 76/19

(57) ABSTRACT

Provided by the present disclosure are a method and device for processing a link failure, a terminal device and a storage medium, the method comprising: detecting whether an SCell link experiences a failure; and if a failure occurs, according to an SpCell state corresponding to the SCell, determining whether link failure recovery for the SCell fails and/or whether to stop carrying out the link failure recovery for the SCell.

### CROSS-REFERENCE TO RELATED APPLICATION

This application is a continuation application of International Application No. PCT/CN2018/108412 filed on Sep. 28, 2018, of which the entire disclosure is hereby incorporated by reference.

### TECHNICAL FIELD

The present disclosure relates to the communication technology, in particular to a method for processing a link failure, an apparatus, a terminal device and a storage medium.

### BACKGROUND

With development of communication technologies, users' requirements for transmission capacity and network coverage, etc., are becoming higher. In order to meet the requirements of the users, each terminal device in a wireless communication system may transmit information on multiple serving cells. The multiple serving cells at least may include a Special cell (SpCell) and a Secondary cell (SCell).

When a link of an SpCell of a multi-beam/multiple beam system fails, a terminal device may recover a link failure through a link recovery procedure, which is also called as a beam failure recovery procedure. However, by listening to a response returned by a network side, the terminal device determines whether the link failure of the SpCell is successfully recovered.

Furthermore, the above link recovery procedure is only for the SpCell, and a link processing solution is urgently needed to process a link of an SCell.

### SUMMARY

Implementations of the present disclosure provide a method for processing a link failure, an apparatus, a terminal device and a storage medium.

In a first aspect, an implementation of the present disclosure provides a method for processing a link failure, which includes: detecting whether a link of a Secondary cell (SCell) fails; and if the link of the Secondary cell (SCell) fails, determining whether a link failure recovery of the SCell fails and/or whether to stop performing the link failure recovery of the SCell according to a state of a special cell (SpCell) corresponding to the SCell.

In a second aspect, an implementation of the present disclosure further provides a method for processing a link failure, which includes detecting whether a link of a Secondary cell (SCell) fails, and if the link failure of the SCell fails and a deactivation timer of the SCell expires, determining that a link failure recovery of the SCell fails and/or to stop performing the link failure recovery of the SCell.

In a third aspect, an implementation of the present disclosure further provides a method for processing a link failure, which includes determining whether a link failure recovery of a Secondary cell (SCell) fails and/or determining whether to stop performing the link failure recovery of the SCell, and if the link failure recovery of the SCell fails and/or performing the link failure recovery of the SCell is stopped, performing at least one of following acts: sending a first notification to a special cell (SpCell), herein the first notification is used for indicating that the link failure recovery of the SCell fails; transmitting a Physical Uplink Control Channel (PUCCH) on the SpCell; stopping receiving a Physical Downlink Control Channel (PDCCH) on the SCell; starting a timer of the SCell, and deactivating the SCell if reconfiguration or activation signaling of the SCell is not received before the timer expires; deactivating the SCell; or sending a second notification to a network device, herein the second notification is used for indicating that the link failure recovery on the SCell fails.

In a fourth aspect, an implementation of the present disclosure further provides a method for processing a link failure, which includes determining a state of a Secondary cell (SCell); and starting or restarting a deactivation timer of the SCell according to the state of the SCell.

In a fifth aspect, an implementation of the present disclosure further provides a method for processing a link failure, which includes detecting whether a link of a Secondary cell (SCell) fails; and if the link of the SCell fails and a response returned by a network device is received, determining not to start or restart a deactivation timer of the SCell.

In a sixth aspect, an implementation of the present disclosure further provides an apparatus for processing a link failure, which includes a detecting module and a determining module.

The detecting module is configured to detect whether a link of a Secondary cell (SCell) fails, and the determining module is configured to determine whether a link failure recovery of the SCell fails and/or whether to stop a link failure recovery of the SCell if the link of the Secondary cell (SCell) fails.

In a seventh aspect, an implementation of the present disclosure further provides an apparatus for processing a link failure, which includes a detecting module and a determining module.

The detecting module is configured to detect whether a link of a Secondary cell (SCell) fails, and the determining module is configured to determine that a link failure recovery of the SCell fails and/or to stop performing the link failure recovery of the SCell if the link of the SCell fails and a deactivation timer of the SCell expires.

In an eighth aspect, an implementation of the present disclosure further provides an apparatus for processing a link failure, which includes a determining module and a performing module.

The determining module is configured to determine whether a link failure recovery of a Secondary cell (SCell) fails and/or whether to stop performing the link failure recovery of the SCell, and the performing module is configured to, if the link failure recovery of the SCell fails and/or performing the link failure recovery of the SCell is stopped, perform at least one of following acts: sending a first notification to a special cell (SpCell), herein the first notification is used for indicating that the link failure recovery of the SCell fails; transmitting a Physical Uplink Control Channel (PUCCH) on the SpCell; stopping receiving a Physical Downlink Control Channel (PDCCH) on the SCell; starting a timer of the SCell, and deactivating the SCell if reconfiguration or activation signaling of the SCell is not received before the timer expires; deactivating the SCell; or sending a second notification to a network device, herein the second notification is used for indicating that the link failure recovery on the SCell fails.

In a ninth aspect, an implementation of the present disclosure further provides an apparatus for processing a link failure, which includes a determining module and a starting module.

The determining module is configured to determine a state of a Secondary cell (SCell), and the starting module is configured to start or restart a deactivation timer of the SCell according to the state of the SCell.

In a tenth aspect, an implementation of the present disclosure further provides an apparatus for processing a link failure, which includes a detecting module and a determining module.

The detecting module is configured to detect whether a link of a Secondary cell (SCell) fails, and the determining module is configured to determine not to start or restart a deactivation timer of the SCell if the link of the SCell fails and a response returned by a network device is received.

In an eleventh aspect, an implementation of the present disclosure further provides a terminal device, which includes a memory and a processor. Herein the memory is configured to store program instructions, and the processor is configured to execute the program instructions stored in the memory, so as to perform the method for processing a link failure according to any one of the above first aspect, the second aspect, the third aspect, the fourth aspect or the fifth aspect.

In a twelfth aspect, an implementation of the present disclosure further provides a computer-readable storage medium, on which a computer program is stored, and when the computer program is executed by a processor, the method for processing a link failure according to any one of the above first aspect, the second aspect, the third aspect, the fourth aspect or the fifth aspect is implemented.

### BRIEF DESCRIPTION OF DRAWINGS

To describe technical solutions in implementations of the present disclosure or the prior art more clearly, accompanying drawings that need to be used in the description of the implementations or the prior art will be briefly introduced below. It is apparent that the accompanying drawings described below are some implementations of the present disclosure, and for a person of ordinary skill in the art, other drawings may be obtained according to these drawings without paying an inventive effort.

FIG. 1 is a schematic diagram of a scenario of a terminal device according to an implementation of the present disclosure.

FIG. 2 is a first flow chart of a method for processing a link failure according to an implementation of the present disclosure.

FIG. 3 is a first schematic diagram of a structure of an apparatus for processing a link failure according to an implementation of the present disclosure.

FIG. 4 is a second schematic diagram of a structure of an apparatus for processing a link failure according to an implementation of the present disclosure.

FIG. 5 is a third schematic diagram of a structure of an apparatus for processing a link failure according to an implementation of the present disclosure.

FIG. 6 is a fourth schematic diagram of a structure of an apparatus for processing a link failure according to an implementation of the present disclosure.

FIG. 7 is a fifth schematic diagram of a structure of an apparatus for processing a link failure according to an implementation of the present disclosure.

FIG. 8 is a schematic diagram of a structure of a terminal device according to an implementation of the present disclosure.

### DETAILED DESCRIPTION

A method for processing a link failure, an apparatus and a terminal device provided in following implementations of the present disclosure are applicable to a mobile communication system that can realize a multi-beam system. In the mobile communication system of the multi-beam system, for example, through a Carrier Aggregation (CA) technology, radio resources of multiple cells or base stations may be concentrated to serve one terminal device, so as to meet users' requirements of capacity and coverage. The mobile communication system may be a Long Term Evolution (LTE) communication system, a 5G communication system such as a new radio access technology (NR) communication system, and other subsequent communication systems that may support a multi-beam system, such as a 6G communication system.

For convenience of understanding implementations of the present disclosure, description will be given in detail as follows by taking a scenario shown in FIG. 1 as an example. FIG. 1 is a schematic diagram of a scenario of a terminal device according to an implementation of the present disclosure. As shown in FIG. 1, a terminal device 10 may support multiple serving cells, that is, it may transmit information on multiple serving cells. The multiple serving cells may at least include an SpCell and an SCell. That is, the terminal device 10 may be located within a range of the SpCell, or located within a range of the SCell.

It should be understood that FIG. 1 is only an illustrative and simplified schematic diagram for convenience of understanding, and the multiple serving cells supported by the terminal device 10 may also include others, but not limited to the SpCell and the SCell shown in FIG. 1.

The multiple serving cells may be serving cells under one network device or serving cells under multiple network devices.

In an example, if the terminal device 10 is connected with one network device (not shown), the multiple serving cells may include cells of the one network device, wherein the SpCell is a primary cell (PCell) of the one network device and the SCell is a secondary cell under the one network device.

In another example, if the terminal device 10 may be connected with two network devices (not shown), i.e., a primary network device and a secondary network device, the multiple serving cells may include cells under the primary network device and the secondary network device. Herein, a cell of the primary network device may be called a Master Cell Group (MCG), and a cell of the secondary network device may be called a cell in a Secondary Cell Group (SCG). Each of a primary cell (PCell) in the MCG and a primary serving cell (PSCell) in the SCG may be called an SpCell. All of other cells in the MCG or other cells in the SCG may all be called SCells.

It should be understood that no matter whether the terminal device 10 is connected with one network device or two network devices, the network device connected with the terminal device 10 may be an access network device, e.g., any access network device such as a Base Transceiver Station (BTS), a base station (Node Base, NodeB), an evolutional Node B (eNB), a base station (such as a gNB) in a 5G NR system, etc., which is not limited in the present disclosure.

The terminal device 10 may also be called a User Equipment (UE), which may be a mobile phone, a tablet computer (Pad), a computer, a virtual reality (VR) terminal device or an augmented reality (AR) terminal device with a wireless transceiving function, a wireless terminal in industrial control, a wireless terminal in self driving, etc. Implementations of the present disclosure do not limit application scenarios. In the present disclosure, the aforementioned terminal device and a chip that may be installed in the aforementioned terminal device are collectively called terminal devices.

It should be noted that in implementations of the present disclosure, a terminal device supports a serving cell may mean that the terminal device may communicate with a network device through a beam of the serving cell, and a link of a cell involved in the following description may be called a link corresponding to a beam of the cell, and a link failure of the cell may also be called a beam failure.

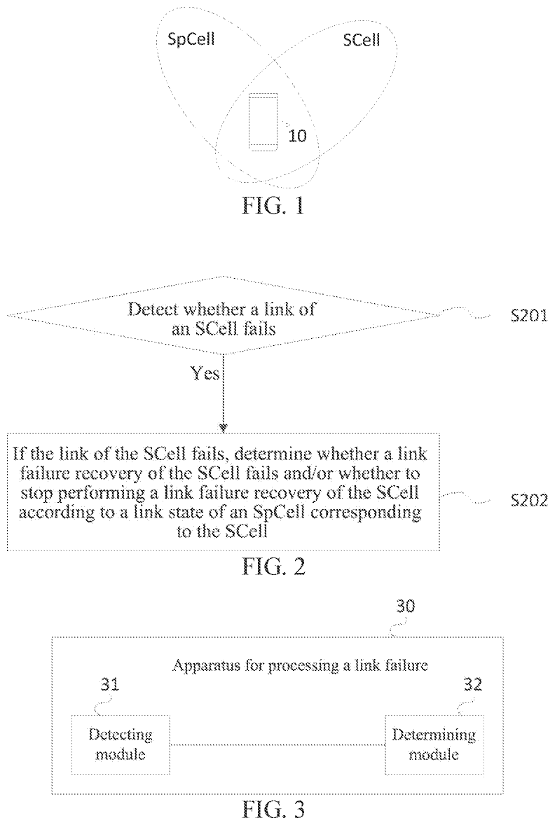

Solutions provided by implementations of the present disclosure will be described in combination with multiple examples as below. FIG. 2 is a flow chart of a method for processing a link failure according to an implementation of the present disclosure. The method for processing a link failure shown in FIG. 2 may be implemented by the terminal device by software and/or hardware. As shown in FIG. 2, the method for processing a link failure may include following act S201.

In S201, detecting whether a link of an SCell fails.

The link of the SCell may also be called a link corresponding to a beam of the SCell.

In a specific implementation, the terminal device may measure a signal quality of a reference signal (e.g., a CSI-RS signal, a synchronization signal block (SS/PBCH block)) corresponding to a downlink control channel in the SCell, and determine whether the measured signal quality meets a preset condition, such as a preset condition corresponding to a block error rate (BLER) or the like. If the signal quality is better than the preset condition, it may be determined that the link of the SCell does not fail. On the contrary, if the signal quality is worse than the preset condition (according to a system configuration, it may need to be worse than the preset condition for multiple times successively), it may be determined that the link of the SCell fails.

Herein, the downlink channel may be a Physical Downlink Control Channel (PDCCH). The reference signal may include, for example, a Channel State Information-Reference Signal (CSI-RS) and/or a synchronization signal block (SS/PBCH block, SSB).

Herein, an SS is a synchronization signal, and a PBCH is a physical broadcast channel block.

If it is determined by performing S201 that the link of the SCell fails, continue to perform following act S202.

If it is determined by performing S201 that the link of the SCell does not fail, there is no need to perform following acts.

In S202, if the link of the SCell fails, it is determined whether a link failure recovery of the SCell fails and/or whether to stop performing a link failure recovery of the SCell according to a link state of an SpCell corresponding to the SCell.

As the SCell is usually used in association with the SpCell, the SpCell corresponding to the SCell may be an SpCell in association with the SCell.

The link state of the SpCell may include at least one of following states: whether a link of the SpCell fails, whether a link failure recovery of the SpCell fails, or whether a Radio Link Failure (RLF) of the SpCell occurs.

As some parameters required by the SCell need to be transmitted through the SpCell, when a link of the SCell fails, it may be determined whether a link failure recovery of the SCell fails and/or whether to stop performing a link failure recovery of the SCell according to the link state of the SpCell.

Herein, whether to stop performing the link failure recovery of the SCell refers to whether to stop performing an unexecuted operation of the link failure recovery of the SCell.

In the method, it may be determined whether the link failure recovery of the SCell fails according to the link state of the SpCell; or, it may be determined whether to stop performing the link failure recovery of the SCell according to the link state of the SpCell; or, it may be determined whether the link failure recovery of the SCell fails and whether to stop performing the link failure recovery of the SCell according to the link state of the SpCell.

The method for processing a link failure provided by the implementation of the present disclosure may detect whether a link of an SCell fails, and if the link of the SCell fails, determine whether a link failure recovery of the SCell fails and/or whether to stop performing a link failure recovery of the SCell according to a state of an SpCell corresponding to the SCell. According to the method for processing a link failure, when a link of an SCell fails, a link failure recovery result of the SCell and/or an operation execution situation in a link failure recovery process of the SCell may be determined in advance according to a state of the SpCell, thus an operation of a terminal device is clearly determined, some unnecessary operations are avoided, and power consumption of the device is reduced.

In a possible implementation, based on the above method, if the link of the SCell fails in above act S202, determining whether the link failure recovery of the SCell fails and/or whether to stop performing the link failure recovery of the SCell according to the link state of the SpCell corresponding to the SCell may include that if the link of the SpCell fails, determining that the link failure recovery of the SCell fails and/or to stop performing the link failure recovery of the SCell.

In the implementation, if the link of the SCell fails, it may be detected whether a link of the SpCell corresponding to the SCell fails, and if the link of the SpCell fails, it is determined that the link failure recovery of the SCell fails and/or to stop performing the link failure recovery of the SCell. That is, when both of the link of the SCell and the link of the SpCell fail, it may be determined that the link failure recovery of the SCell fails and/or to stop performing the link failure recovery of the SCell.

A specific implementation of detecting whether the link of the SpCell fails may be similar to the implementation of detecting whether the link of the SCell fails in above act S201, and the above description may be referred to for details, and is not repeated here again.

In a case that the link of the SCell fails and the link of the SpCell also fails, as some parameters required by the SCell need to be transmitted through the SpCell, it may be determined that the link failure recovery of the SCell will fail, and there is no need to continue performing the link failure recovery of the SCell, so performing the link failure recovery of the SCell may be stopped.

In a case that the link of the SCell fails, but the link of the SpCell does not fail, it may be determined that the link failure recovery of the SCell may be successful, so it may be determined not to stop performing the link failure recovery of the SCell, i.e., the link failure recovery of the SCell may be attempted to perform.

For example, the terminal device may determine a reference signal that meets a preset condition by measuring a received reference signal. The preset condition may be, for example, a preset condition of at least one parameter, such as a Reference Signal Receiving Power (RSRP) of Layer 1, a Reference Signal Receiving Quality (RSRQ) of Layer 1, or Layer 1 Signal to Interference plus Noise Ratio (L1-SINR), etc.

If no reference signal that meets the preset condition is selected, the terminal device may access the SCell of the network device in a contention-based random access mode.

In one mode, if a reference signal that meets the preset condition is selected, the terminal device may send a link failure recovery request, which is also called a beam failure recovery request or random access information, etc., to the network device through a Physical Random Access Channel (PRACH) corresponding to the reference signal.

In another mode, the terminal device may send a Physical Uplink Control Channel (PUCCH) to the network device, and the PUCCH may include information such as an identifier of a link corresponding to the reference signal, or the like. There may be one or more links corresponding to the reference signal, and the links corresponding to the reference signal may also be called candidate links, such as links corresponding to candidate beams.

In yet another mode, the terminal device may send Media Access Control (MAC) Control Element (CE) signaling to the network device. Herein the MAC CE signaling may include information such as an identifier of a link corresponding to the reference signal, or the like. There may be one or more links corresponding to the reference signal, and the links corresponding to the reference signal may also be called candidate links, such as links corresponding to candidate beams.

The terminal device may also listen to a response returned by the network device, in any one case of sending a link failure recovery request to the network device, or reporting a target link to the network device through a PUCCH or an MAC CE signaling, or the like. When the response returned by the network device is received, it may be determined that the link failure recovery of the SCell is successful.

In the method for processing a link failure provided by the implementation of the present disclosure, when both a link of the SCell and a link of the SpCell corresponding to the SCell fail, it may be determined in advance that a link failure recovery of the SCell will fail and/or to stop performing the link failure recovery of the SCell, which may avoid performing an unnecessary operation of the SCell by the terminal device, and reduce power consumption of the terminal device.

In another possible implementation, based on the above method, if the link of the SCell fails in above act S202, determining whether a link failure recovery of the SCell fails and/or whether to stop performing the link failure recovery of the SCell according to the link state of the SpCell corresponding to the SCell may include if a link of the SpCell fails and a link failure recovery procedure of the SpCell also fails, determining that the link failure recovery of the SCell fails and/or to stop performing the link failure recovery of the SCell.

In the another possible implementation, if a link of the SCell fails, it may be detected whether a link of the SpCell corresponding to the SCell fails. If the link of the SpCell fails, a link failure recovery of the SpCell may be performed, and if the link failure recovery of the SpCell fails, it may be determined that the link failure recovery of the SCell fails and/or to stop performing the link failure recovery of the SCell.

The link failure recovery procedure of the SpCell may be similar to the above link failure recovery procedure of the SCell, and the above description may be referred to for details and is not repeated here again.

If the terminal device does not receive a response returned by the network device in the link failure recovery procedure of the SpCell, it may determine that the link failure recovery of the SpCell fails.

Specifically, if not receiving a response returned by the network device, the terminal device sends a PRACH to the network device again to indicate a target link, or indicates the target link through a PUCCH or an MAC CE signaling.

When any of following conditions is met in the terminal device, it may determine that the link failure recovery of the SpCell fails: a number of times of reporting the target link is greater than or equal to a preset value, but a response returned by the network device has not been received, the link failure recovery of the SpCell fails in a first preset time period; or a reference signal that meets a preset condition is not selected in a second preset time period.

Whatever the link failure recovery of the SpCell is successful or not, the link failure recovery of the SCell may fail.

If the link failure recovery of the SpCell fails, a probability that the link failure recovery of the SCell fails is high, so in this case, the accuracy of determining that the link failure recovery of the SCell fails and/or to stop performing the link failure recovery of the SCell is high.

The method of the implementation of the present disclosure may determine that a link failure recovery of the SCell fails and/or to stop performing the link failure recovery of the SCell when both a link of the SCell and a link of the SpCell corresponding to the SCell fail and a link failure recovery of the SpCell also fails, which effectively improves an accuracy of determination.

In yet another possible implementation, in above act S202, if the link of the SCell fails, determining whether the link failure recovery of the SCell fails and/or whether to stop performing the link failure recovery of the SCell according to the link state of the SpCell corresponding to the SCell may include that if an RLF occurs in the SpCell, determining that the link failure recovery of the SCell fails and/or to stop performing the link failure recovery of the SCell.

In the another implementation, if the link of the SCell fails, it may be detected whether the link of the SpCell corresponding to the SCell fails, and if the link of the SpCell fails, it is further determined whether an RLF occurs in the SpCell, and if the RLF occurs in the SpCell, determining that the link failure recovery of the SCell fails and/or to stop performing the link failure recovery of the SCell.

When the link of the SpCell, i.e., a link corresponding to a beam of the SpCell fails, a radio link of the SpCell may fail, or may not fail.

The link failure recovery of the SCell may fail, no matter whether a radio link of the SpCell fails. If a radio link of the SpCell fails, a probability that the link failure recovery of the SCell fails is high, so in this case, the accuracy of determining that the link failure recovery of the SCell fails and/or to stop performing the link failure recovery of the SCell is high.

In the method, if the radio link of the SpCell fails, it may be unnecessary to perform the link failure recovery of the SpCell, thus some unnecessary operations are avoided, and power consumption of the terminal device is reduced.

The method of the implementation of the present disclosure may determine that a link failure recovery of the SCell fails and/or to stop performing the link failure recovery of the SCell when both a link of the SCell and a link of the SpCell corresponding to the SCell fail and an RLF of the SpCell occurs, which effectively improves an accuracy of determination.

Optionally, based on the above method, if it is determined that the link of the SCell fails by performing above act S201, the method may further include if a first timer of the SCell expires, determining that the link failure recovery of the SCell fails and/or to stop performing the link failure recovery of the SCell, herein the first timer is a deactivation timer.

The first timer of the SCell may be a secondary cell deactivation timer (sCellDeactivationTimer), which may also be called an invalidation timer.

There may be one timer corresponding to each serving cell to record a failure duration of a link of the serving cell.

It should be noted that if the first timer expires, it may be directly determined that the link failure recovery of the SCell fails and/or to stop performing the link failure recovery of the SCell, and some other determination conditions may also be taken into account, and when other determination conditions are also reached, it may be determined that the link failure recovery of the SCell fails and/or to stop performing the link failure recovery of the SCell.

The other determination conditions may include at least one of following: the link of the SpCell fails as shown above, the link failure recovery of the SpCell fails as shown above, or the RLF of the SpCell occurs as shown above.

A specific implementation process for the other determination conditions may refer to the above description, which is not repeated herein again.

The method of the implementation of the present disclosure may determine that the link failure recovery of the SCell fails and/or to stop performing the link failure recovery of the SCell when the link of the SCell fails and the invalidation timer of the SCell expires, which effectively improves an accuracy of determination.

In an implementation of the present disclosure, the first timer may be started or restarted according to a state of the SCell. The state of the SCell may include any one state of the following: the link of the SCell fails; the link of the SCell fails, and a reference signal that meets a preset condition exists; or it is the time when or after a link failure recovery request is sent to the network device in a failure recovery process of the SCell.

That is to say, in the method of the implementation of the present disclosure, the first timer may be started or restarted when the link of the SCell fails; or the first timer may be started or restarted when the link of the SCell fails and a reference signal that meets a preset condition exists; or the first timer may be started or restarted when or after a link failure recovery request is sent to the network device in the failure recovery process of the SCell.

In the method of the present disclosure, the first timer may be started or restarted based on the state of the SCell, without the need to start or restart the first timer when data are sent or received, which realizes starting or restarting the first timer in advance, so as to obtain more time to operate, thereby avoiding performing deactivation of the SCell too early.

It should be noted that in the method, a link failure recovery request may be sent to the network device through a PRACH according to a target link, or a link failure recovery request may be sent to the network device through a PUCCH or MAC CE signaling, etc.

Optionally, the method may further include determining not to start or restart the first timer if a response returned by the network device is received.

For the first timer of the SCell as shown above, i.e., a deactivation timer of the SCell, when receiving the response returned by the network device, the terminal device may determine that the link failure recovery of the SCell is successful and it is unnecessary to start the first timer, so it determines not to start or restart the first timer.

In the solution, when a response returned by the network device is received, it is determined not to start or restart the first timer, which may avoid an unnecessary operation and save power consumption.

When the link failure recovery of the SCell fails, the implementation of the present disclosure may further provide a method for processing a link failure. In the implementation of the present disclosure, the terminal device may determine whether the link failure recovery of the SCell fails, and/or, whether to stop performing the link failure recovery of the SCell by adopting any of the methods shown in FIG. 2 to FIG. 5, which is not repeated here again.

The terminal device may determine that the link failure recovery of the SCell fails, and/or, whether to stop performing the link failure recovery of the SCell by other way.

In the other way, the terminal device may perform a link failure recovery of the SCell when determining that a link of the SCell fails. A specific link failure recovery procedure of the SCell may refer to the above description, which is not repeated here again. In a process of performing the link failure recovery of the SCell, when a number of times of reporting a target link is greater than or equal to a preset value but a response returned by the network device has not been received, it may be determined that the link failure recovery of the SCell fails and/or to stop performing the link failure recovery of the SCell. Or, if the link failure recovery of the SCell fails in a third preset time period, it is determined that the link failure recovery of the SCell fails and/or to stop performing the link failure recovery of the SCell. Or, if a reference signal that meets the preset condition is not selected in a fourth preset time period, then it is determined that the link failure recovery of the SCell fails and/or to stop performing the link failure recovery of the SCell.

If determining that the link failure recovery of the SCell fails and/or to stop performing the link failure recovery of the SCell, the terminal device may further perform at least one of following operations: sending a first notification to the SpCell, herein the first notification may be used for indicating that the link failure recovery of the SCell fails; transmitting a PUCCH on the SpCell; stopping receiving a PDCCH on the SCell, starting a second timer of the SCell, and deactivating the SCell if a reconfiguration or activation signaling of the scell is not received before the second timer expires; deactivating the SCell; or sending a second notification to the network device, herein the second notification is used for indicating that the link failure recovery of the SCell fails.

Specifically, the terminal device may send the first notification through a primary processor or a logical processing unit of the SCell.

When determining that the link failure recovery of the SCell fails and/or to stop performing the link failure recovery of the SCell but a link of the SpCell does not fail or a link failure recovery of the SpCell is successful, the terminal device may drop a PUCCH configured in the SCell back to the SpCell, so as to transmit the PUCCH on the SpCell, ensuring a normal transmission of the PUCCH. Herein, the PUCCH may be a PUCCH corresponding to a CA. Optionally, before transmitting the PUCCH on the SpCell, the terminal device may receive resource configuration information sent by the network device, and the resource configuration information may be resource configuration information corresponding to a resource of the PUCCH on the SpCell.

When determining that the link failure recovery of the SCell fails and/or to stop performing the link failure recovery of the SCell, the terminal device may stop receiving a PDCCH on the SCell by stopping a PDCCH monitoring operation on the SCell, thereby reducing unnecessary power consumption.

The second timer of the SCell may be the above deactivation timer, or may reuse any other timer of the SCell, or may be a preset timer to be used when the link failure recovery of the SCell fails. Reconfiguration signaling of the SCell may be Radio Resource Control (RRC) signaling of the SCell, and activation signaling of the SCell may be MAC CE signaling of the SCell.

In a solution of the implementation of the present disclosure, the terminal device may deactivate the SCell when the link failure recovery of the SCell fails and/or performing the link failure recovery of the SCell is stopped and the reconfiguration or activation signaling of the SCell is not received before the second timer expires. The terminal device may directly deactivate the SCell when the link failure recovery of the SCell fails and/or performing the link failure recovery of the SCell is stopped. By deactivating the SCell, the SCell may be caused to be invalid, so as to release resources of the SCell, thereby improving utilization of the resources.

The terminal device directly sends a second notification to the network device to indicate that the link failure recovery of the SCell fails when the link failure recovery of the SCell fails and/or performing the link failure recovery of the SCell is stopped. The second notification may be sent to the network device to indicate that the link failure recovery of the SCell fails when the link failure recovery of the SCell fails and/or performing the link failure recovery of the SCell is stopped and the above operations are performed, for example, the second notification may be sent to the network device to indicate that the link failure recovery of the SCell fails when the SCell is deactivated. The terminal device sends the second notification to the network device to indicate that the link failure recovery of the SCell fails, which may cause the network device to release resources of the SCell, thereby improving utilization of the resources.

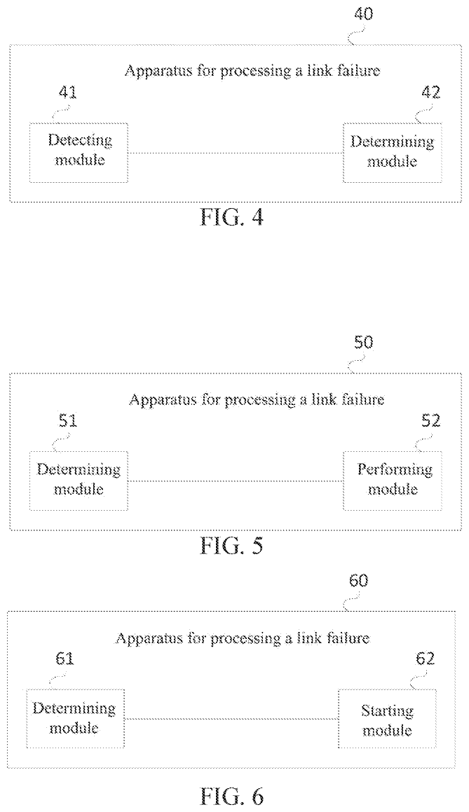

An implementation of the present disclosure may further provide an apparatus for processing a link failure. The apparatus for processing the link failure may be a terminal device, a general processor of the terminal device, also called a chip, or a processing circuit of the terminal device. FIG. 3 is a schematic diagram one of a structure of an apparatus for processing a link failure according to an implementation of the present disclosure. As shown in FIG. 3, the apparatus 30 for processing a link failure may include a detecting module 31 and determining module 32.

The detecting module 31 is configured to detect whether a link of an SCell fails, and the determining module 32 is configured to, if the link of the SCell fails, determine whether a link failure recovery of the SCell fails and/or whether to stop performing a link failure recovery of the SCell according to a state of an SpCell corresponding to the SCell.

Optionally, the determining module 32 is specifically configured to determine that the link failure recovery of the SCell fails and/or to stop performing the link failure recovery of the SCell if the link of the SpCell fails.

Optionally, the determining module 32 is specifically configured to determine that the link failure recovery of the SCell fails and/or to stop performing the link failure recovery of the SCell if the link of the SpCell fails and a link failure recovery procedure of the SpCell also fails.

Optionally, the determining module 32 is specifically configured to determine that the link failure recovery of the SCell fails and/or to stop performing the link failure recovery of the SCell if an RLF occurs in the SpCell.

Optionally, the determining module 32 is further configured to determine that the link failure recovery of the SCell fails and/or to stop performing the link failure recovery of the SCell if a first timer of the SCell expires, herein the first timer is a deactivation timer.

Optionally, the apparatus 30 for processing the link failure further includes a starting module, and the starting module is configured to start or restart the first timer according to a state of the SCell before the determining module 32 determines whether the first timer of the SCell expires.

Optionally, the starting module is specifically configured to start or restart the first timer if the link of the SCell fails.

Optionally, the starting module is specifically configured to start or restart the first timer if the link of the SCell fails and a reference signal that meets a preset condition exists.

Optionally, the starting module is specifically configured to start or restart the first timer when or after a link failure recovery request is sent to the network device in a link failure recovery procedure corresponding to the SCell.

Optionally, the determining module 32 is further configured to determine not to start or restart the first timer if a response returned by the network device is received.

Optionally, if the link failure recovery of the SCell fails and/or performing the link failure recovery of the SCell is stopped, the apparatus 30 for processing the link failure further includes a performing module, and the performing module is configured to perform at least one of following acts: sending a first notification to the SpCell, herein the first notification is used for indicating that the link failure recovery of the SCell fails; stopping receiving a PDCCH on the SCell; or sending a second notification to the network device, herein the second notification is used for indicating that the link failure recovery of the SCell fails.

Optionally, if the link failure recovery of the SCell fails and/or performing the link failure recovery of the SCell is stopped, the apparatus 30 for processing the link failure further includes an activating module, and the activating module is configured to deactivate the SCell.

Optionally, the activating module is specifically configured to start a second timer of the SCell, and deactivate the SCell if reconfiguration or activation signaling of the SCell is not received before the second timer expires.

It should be understood that the apparatus 30 for processing the link failure has other functions of the terminal device in any of the above methods, and the other functions and beneficial effects thereof may refer to the above description, which are not repeated here again.

An implementation of the present disclosure may further provide an apparatus for processing a link failure. The apparatus for processing the link failure may be a terminal device, a general processor of the terminal device, also called a chip, or a processing circuit of the terminal device. FIG. 4 is a schematic diagram two of a structure of an apparatus for processing a link failure according to an implementation of the present disclosure. As shown in FIG. 4, the apparatus 40 for processing a link failure may include a detecting module 41 and a determining module 42.

The detecting module 41 is configured to detect whether a link of an SCell fails, and the determining module 42 is configured to determine that a link failure recovery of the SCell fails and/or to stop performing the link failure recovery of the SCell if the link of the SCell fails and a deactivation timer of the SCell expires.

It should be understood that the apparatus 40 for processing the link failure also has other functions of the terminal device in any of the above methods, and the other functions and beneficial effects thereof may refer to the above description, which are not repeated here again.

An implementation of the present disclosure may further provide an apparatus for processing a link failure. The apparatus for processing the link failure may be a terminal device, a general processor of the terminal device, also called a chip, or a processing circuit of the terminal device. FIG. 5 is a schematic diagram three of a structure of an apparatus for processing a link failure according to an implementation of the present disclosure. As shown in FIG. 5, the apparatus 50 for processing a link failure may include a determining module 51 and a performing module 52.

The determining module 51 is configured to determine whether a link failure recovery of an SCell fails and/or whether to stop performing the link failure recovery of the SCell, and the performing module 52 is configured to, if the link failure recovery of the SCell fails and/or performing the link failure recovery of the SCell is stopped, perform at least one of following acts: sending a first notification to an SpCell, herein the first notification is used for indicating that the link failure recovery of the SCell fails; transmitting a PUCCH on the SpCell; stopping receiving a PDCCH on the SCell; starting a timer of the SCell, and deactivating the SCell if reconfiguration or activation signaling of the SCell is not received before the timer expires; deactivating the SCell; or sending a second notification to the network device, herein the second notification is used for indicating that the link failure recovery on the SCell fails.

It should be understood that the apparatus 50 for processing the link failure also has other functions of the terminal device in any of the above methods, and the other functions and beneficial effects thereof may refer to the above description, which are not repeated here again.

An implementation of the present disclosure may further provide an apparatus for processing a link failure. The apparatus for processing the link failure may be a terminal device, a general processor of the terminal device, also called a chip, or a processing circuit of the terminal device. FIG. 6 is a schematic diagram four of a structure of an apparatus for processing a link failure according to an implementation of the present disclosure. As shown in FIG. 6, the apparatus 60 for processing a link failure may include a determining module 61 and a starting module 62.

The determining module 61 is configured to determine a state of an SCell, and the starting module 62 is configured to start or restart a deactivation timer of the SCell according to the state of the SCell.

Optionally, the starting module 62 is specifically configured to start or restart the deactivation timer of the SCell if a link of the SCell fails.

Optionally, the starting module 62 is specifically configured to start or restart the deactivation timer of the SCell if the link of the SCell fails and a reference signal that meets a preset condition exists.

Optionally, the starting module 62 is specifically configured to start or restart the deactivation timer of the SCell when or after a link failure recovery request is sent to a network device in a link failure recovery procedure of the SCell.

Optionally, the apparatus 60 for processing the link failure further includes that the determining module 61 is specifically configured to determine not to start or restart the deactivation timer of the SCell if a response returned by the network device is received.

It should be understood that the apparatus 60 for processing the link failure also has other functions of the terminal device in any of the above methods, and the other functions and beneficial effects thereof may refer to the above description, which are not repeated here again.

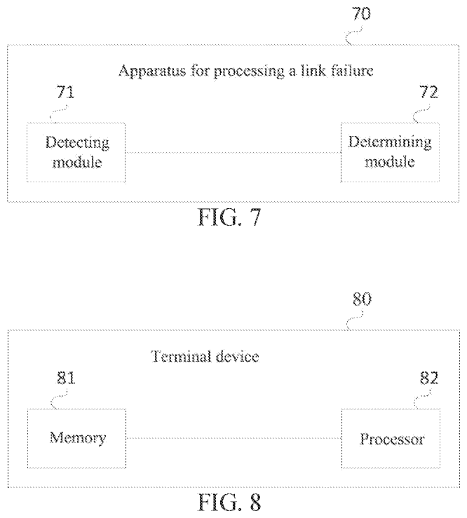

An implementation of the present disclosure may further provide an apparatus for processing a link failure. The apparatus for processing the link failure may be a terminal device, a general processor of the terminal device, also called a chip, or a processing circuit of the terminal device. FIG. 7 is a schematic diagram five of a structure of an apparatus for processing a link failure according to an implementation of the present disclosure. As shown in FIG. 7, the apparatus 70 for processing a link failure may include a detecting module 71 and determining module 72.

The detecting module is configured to detect whether a link of an SCell fails, and the determining module 72 is configured to determine not to start or restart a deactivation timer of the SCell if the link of the SCell fails and a response returned by a network device is received.

It should be understood that the apparatus 70 for processing the link failure also has any function of the terminal device in any of the above methods, and the any function and a beneficial effect thereof may refer to the above description, which are not repeated here again.

An implementation of the present disclosure may further provide a terminal device. FIG. 8 is a schematic diagram of a structure of a terminal device according to an implementation of the present disclosure. As shown in FIG. 8, the terminal device 80 may include a memory 81 and a processor 82.

The memory 81 is configured to store program instructions, and the processor 82 is configured to execute the program instructions stored in the memory, so as to perform the method for processing a link failure shown by any of the above.

An implementation of the present disclosure may further provide a computer-readable storage medium, on which a computer program is stored, when being executed by a processor, the computer program implements the method for processing a link failure shown by any of the above.

An implementation of the present disclosure may further provide a computer program product, which may be executed by a processor, for example, by the processor 82 of the terminal device 80. When being executed, the computer program product may implement the method for processing a link failure shown by any of the above.

The terminal device, the computer readable storage medium and the computer program product of the implementations of the present disclosure may perform any of the above methods for processing link failures, and specific implementation processes and beneficial effects thereof may refer to above description, which are not repeated here again.

The term “and/or” in this document is merely an association relationship describing associated objects, indicating that there may be three relationships, for example, A and/or B may indicate three situations: A alone, A and B and B alone. In addition, the symbol “/” in this document generally indicates that objects before and after the symbol “/” have an “or” relationship.

It should be understood that in the implementations of the present disclosure, “B corresponding to A” means that B is associated with A, and B may be determined according to A. However, it should be further understood that determining B according to A does not mean B is determined according to A only, but B may be determined according to A and/or other information.

In the present disclosure, “at least one” means one or more, and “multiple” means two or more. The term “and/or” describes an association relationship of associated objects, indicating that there may be three relationships, for example, A and/or B may represent situations: A alone. A and B at the same time, and B alone, herein A, B may be singular number or plural number. Symbol “/” generally indicates that objects before and after the symbol “/” is in an “or” relationship. An expression “at least one of the following” or the like refers to any combination thereof, including any combination of singular item or plural items. For example, at least one of a, b or c may represent: a, b, c, a & b, a & c, b & c, or a & b &c, herein a, b and c may be single or plural.

Those of ordinary skill in the art will recognize that various example units and algorithm acts described in connection with the implementations disclosed herein can be implemented in electronic hardware, or computer software or a combination of computer software and electronic hardware. In order to explain interchangeability of software and hardware clearly, a composition of examples and acts in the examples are described generally with respect to functions in the above description. Whether these functions are implemented in hardware or software depends on a specific application and design constraints of the technical solution. Skilled persons in the art may use different methods to implement the described functions in respect to each particular application, but such implementation should not be considered to be beyond the scope of the present disclosure.

Those skilled in the art may clearly understand that for convenience and conciseness of description, specific working processes of the system, device and unit described above may refer to the corresponding processes in the aforementioned method implementations and will not be described herein.

The foregoing description is merely specific implementations of implementations of the present disclosure, but the protection scope of the implementations of the present disclosure is not limited thereto. Any person skilled in the art may easily conceive variations or substitutions within the technical scope disclosed by the present disclosure, which should be included within the protection scope of the implementations of the present disclosure. Therefore, the protection scope of the implementations of the present disclosure should be subject to the protection scope of the claims.

What is claimed is:

1. A method for processing a link failure, comprising:
detecting whether a link of a Secondary cell (SCell) fails; and
if the link of the SCell fails, determining whether a link failure recovery of the SCell fails and/or whether to stop performing the link failure recovery of the SCell according to a state of a special cell (SpCell) corresponding to the SCell.

2. The method according to claim 1, wherein if the link of the SCell fails, determining whether the link failure recovery of the SCell fails and/or whether to stop performing the link failure recovery of the SCell according to the state of the SpCell corresponding to the SCell comprises:
if the link of the SpCell fails, determining that the link failure recovery of the SCell fails and/or to stop performing the link failure recovery of the SCell.

3. The method according to claim 1, wherein if the link of the SCell fails, determining whether the link failure recovery of the SCell fails and/or whether to stop performing the link failure recovery of the SCell according to the state of the SpCell corresponding to the SCell comprises:
if the link of the SpCell fails and a link failure recovery procedure of the SpCell fails, determining that the link failure recovery of the SCell fails and/or to stop performing the link failure recovery of the SCell.

4. The method according to claim 1, wherein if the link of the SCell fails, determining whether the link failure recovery of the SCell fails and/or whether to stop performing the link failure recovery of the SCell according to the state of the SpCell corresponding to the SCell comprises:
if a Radio Link Failure (RLF) occurs in the SpCell, determining that the link failure recovery of the SCell fails and/or to stop performing the link failure recovery of the SCell.

5. The method according to claim 1, wherein if the link of the SCell fails, the method further comprises:
if a first timer of the SCell expires, determining that the link failure recovery of the SCell fails and/or to stop performing the link failure recovery of the SCell, wherein the first timer is a deactivation timer.

6. The method according to claim 5, wherein before determining whether the first timer of SCell expires, the method further comprises:
starting or restarting the first timer according to a state of the SCell.

7. The method according to claim 5, further comprising:
determining not to start or restart the first timer if a response returned by a network device is received.

8. The method according to claim 1, wherein if the link failure recovery of the SCell fails and/or performing the link failure recovery of the SCell is stopped, the method further comprises at least one of following acts:
sending a first notification to the SpCell, wherein the first notification is used for indicating that the link failure recovery of the SCell fails;
stopping receiving a Physical Downlink Control Channel (PDCCH) on the SCell; or
sending a second notification to a network device, wherein the second notification is used for indicating that the link failure recovery of the SCell fails.

9. The method according to claim 1, wherein if the link failure recovery of the SCell fails and/or performing the link failure recovery of the SCell is stopped, the method further comprises:
deactivating the SCell.

10. The method according to claim 9, wherein deactivating the SCell comprises:
starting a second timer of the SCell; and
deactivating the SCell if reconfiguration or activation signaling of the SCell is not received before the second timer expires.

11. An apparatus for processing a link failure, comprising a memory and a processor, wherein the processor is configured to detect whether a link of a Secondary cell (SCell) fails; and
the processor is further configured to determine, if the link of the SCell fails, whether a link failure recovery of the SCell fails and/or whether to stop performing the link failure recovery of the SCell according to a state of a special cell (SpCell) corresponding to the SCell.

12. The apparatus according to claim 11, wherein
the processor is configured to determine that the link failure recovery of the SCell fails and/or to stop performing the link failure recovery of the SCell if the link of the SpCell fails.

13. The apparatus according to claim 11, wherein
the processor is configured to determine that the link failure recovery of the SCell fails and/or to stop performing the link failure recovery of the SCell if the link failure of the SpCell fails and a link failure recovery procedure of the SpCell fails.

14. The apparatus according to claim 11, wherein
the processor is configured to determine that the link failure recovery of the SCell fails and/or to stop performing the link failure recovery of the SCell if a Radio Link Failure (RLF) occurs in the SpCell.

15. The apparatus according to claim 11, wherein
if the link of the SCell fails, the processor is further configured to determine that the link failure recovery of the SCell fails and/or to stop performing the link failure recovery of the SCell if a first timer of the SCell expires, wherein the first timer is a deactivation timer.

16. The apparatus according to claim 15, wherein
the processor is further configured to start or restart the first timer according to a state of the SCell before the processor determines whether the first timer of the SCell expires.

17. The apparatus according to claim 16, wherein
the processor is configured to start or restart the first timer if the link of the SCell fails.

18. The apparatus according to claim 16, wherein
the processor is configured to start or restart the first timer if the link of the SCell fails and a reference signal that meets a preset condition exists.

19. The apparatus according to claim 16, wherein
the processor is configured to start or restart the first timer when or after a link failure recovery request is sent to a network device in a link failure recovery procedure corresponding to the SCell.

20. A non-transitory computer readable storage medium, on which a computer program is stored, wherein when the computer program is executed by a processor, the method for processing a link failure according to claim 1 is implemented.
